(19) United States
(12) Patent Application Publication
(10) Pub. No.: US 2026/0007113 A1
(43) Pub. Date: Jan. 8, 2026

(54) PLANT CULTIVATION DEVICE AND PLANT CULTIVATION METHOD

(71) Applicant: MITSUBISHI CHEMICAL AQUA SOLUTIONS CO., LTD., Tokyo (JP)

(72) Inventors: Yoshiyuki ISHIHARA, Tokyo (JP); Akio NAKAMINAMI, Tokyo (JP); Tsunehiro ABE, Tokyo (JP); Koichi AIZAWA, Tokyo (JP)

(73) Assignee: MITSUBISHI CHEMICAL AQUA SOLUTIONS CO., LTD., Tokyo (JP)

(21) Appl. No.: 19/323,128

(22) Filed: Sep. 9, 2025

Related U.S. Application Data
(63) Continuation of application No. PCT/JP2024/005536, filed on Feb. 16, 2024.

(30) Foreign Application Priority Data
Mar. 10, 2023 (JP) 2023-038056

(51) Int. Cl. A01G 31/02; A01G 22/05; A01G 31/00

(52) U.S. Cl. CPC A01G 31/024; A01G 22/05; A01G 31/008

(57) ABSTRACT

A plant cultivation device (1) which is an embodiment of a plant cultivation device includes: a cultivation bed (10) having a bottom surface (10a) on which a plant is placed and which is inclined; a first solution supply member (20); and a second solution supply member (30) extending along a direction (F1) in which the bottom surface (10a) is inclined. The second solution supply member (30) includes a plurality of nutrient solution discharge holes disposed along the direction (F1).

This application is a Continuation of PCT International Application No. PCT/JP2024/005536 filed in Japan on Feb. 16, 2024, which claims the benefit of Patent Application No. 2023-038056 filed in Japan on Mar. 10, 2023, the entire contents of which are hereby incorporated by reference.

### TECHNICAL FIELD

The present invention relates to a plant cultivation device and a plant cultivation method.

### BACKGROUND ART

As a plant cultivation method, there is known a nutrient film technique (NFT). Patent Literature 1 discloses a hydroponic cultivation device characterized by including: a cultivation bed which holds a plant, on which a culture solution is supplied to a root system of the plant, and which has a surface inclined in at least two directions; a culture solution supplying means for supplying the culture solution to the inclined surface of the cultivation bed; and a culture solution recovering means for discharging the culture solution from the cultivation bed.

Patent Literature 2 discloses a nutriculture member including: a cultivation bed tank which has a bottom surface having a gradient; and a transplanting panel plate which is disposed on the cultivation bed tank and which is provided with a plurality of planting holes, wherein a seedling stand is provided on the bottom surface of the cultivation bed tank which bottom surface is located below the planting holes, an aeration space is formed between a lower surface of the seedling stand and the bottom surface of the cultivation bed tank, and a plant is disposed on the seedling stand. The nutriculture member is characterized by including a sprinkling member which sprinkles a nutrient solution over a root of the plant on the seedling stand or an upper surface of the seedling stand.

Patent Literature 3 discloses a plant cultivation device including: a sheet member which has water permeability; and a support member which supports the sheet member such that a gap serving as a flow path for a nutrient solution is formed between the sheet member and a bottom of a container.

### CITATION LIST

### Patent Literature

### [Patent Literature 1]

Japanese Patent Application Publication Tokukai No. 2007-89489

### [Patent Literature 2]

Japanese Patent Application Publication Tokukai No. 2019-205426

### [Patent Literature 3]

Japanese Patent Application Publication Tokukai No. 2022-171427

### SUMMARY OF INVENTION

### Technical Problem

For example, in cultivation of a strawberry, there is a demand for an increased planting density, from the viewpoint of improvement in productivity. Therefore, in order to increase the number of cultivation beds that can be installed per unit area, a cultivation bed that is smaller than a cultivation bed for cultivating the other plants such as a cucumber is sometimes used. In a small cultivation bed, there is little room for a root mat to spread on a bottom surface of the cultivation bed. Therefore, the root mat tends to grow in a height direction and increase in thickness. Moreover, also in a case where a cultivation period is a long period (for example, 6 to 12 months), as with a strawberry, a root mat tends to increase in thickness. As a result, there is a problem that a formed root mat blocks a downstream flow of a nutrient solution and accordingly the nutrient solution is likely to have a concentration gradient and a temperature gradient between an upstream side and a downstream side of a flow of the nutrient solution.

An object of an aspect of the present invention is to provide a technique that makes it possible to reduce a concentration gradient and a temperature gradient of a nutrient solution between an upstream side and a downstream side of a flow of the nutrient solution.

### Solution to Problem

In order to attain the above object, a plant cultivation device in accordance with a first aspect of the present invention is configured to include: a cultivation bed having a bottom surface on which a plant is placed and which is inclined; a first solution supply member for supplying a nutrient solution into the cultivation bed; and a second solution supply member extending along a direction in which the bottom surface is inclined, wherein the second solution supply member includes a plurality of discharge holes for discharging the nutrient solution, and the plurality of discharge holes are disposed along the direction in which the bottom surface is inclined. The nutrient solution supplied into the cultivation bed flows on the bottom surface along the direction in which the bottom surface is inclined. In the plant cultivation device in accordance with the first aspect of the present invention, this configuration makes it possible to reduce a concentration gradient and a temperature gradient of the nutrient solution between an upstream side and a downstream side of a flow of the nutrient solution.

The plant cultivation device in accordance with a second aspect of the present invention is preferably configured such that, in the first aspect, a raised part on which the second solution supply member is placed is provided to the bottom surface, and the second solution supply member is placed on the raised part. This makes it possible to supply, along a side surface of the raised part, the nutrient solution discharged from the second solution supply member, and accordingly makes it possible to favorably diffuse the nutrient solution in a direction away from the second solution supply member.

The plant cultivation device in accordance with a third aspect of the present invention is preferably configured such that, in the second aspect, the raised part has an inclined portion which is inclined toward the bottom surface. Since the raised part has the inclined portion, the nutrient solution is more favorably diffused in the direction away from the second solution supply member.

The plant cultivation device in accordance with a fourth aspect of the present invention is preferably configured such that, in any one of the first through third aspects, a groove in which the plant is placed is provided to the bottom surface. By providing the groove to the bottom surface, a difference arises in height between the bottom surface of the cultivation bed and a bottom surface of the groove, and accordingly the nutrient solution flows into the groove. This makes it possible to efficiently direct the nutrient solution into the groove. As a result, it is possible to successfully supply the nutrient solution to the plant placed in the groove.

The plant cultivation device in accordance with a fifth aspect of the present invention is preferably configured such that, in the fourth aspect, the groove extends along the direction in which the bottom surface is inclined. Since the groove extends along the direction in which the bottom surface is inclined, the nutrient solution in the groove favorably flows.

The plant cultivation device in accordance with a sixth aspect of the present invention is preferably configured such that, in the fourth or fifth aspect, the groove includes a plurality of grooves, and the second solution supply member is disposed between adjacent ones of the plurality of grooves. In a case where the groove includes a plurality of grooves, the second solution supply member is disposed between adjacent ones of the plurality of grooves. This makes it possible to reduce a difference in concentration and temperature of the nutrient solution between the plurality of grooves.

The plant cultivation device in accordance with a seventh aspect of the present invention is preferably configured to, in any one of the fourth through sixth aspects, further include a positioning member for the plant, wherein the positioning member has a plurality of planting holes at positions which correspond to the groove in a case where the positioning member is disposed on the cultivation bed. This makes it possible to place the plant on the groove located below the plurality of planting holes, by inserting the plant into each of the plurality of planting holes and thereby transplanting the plant. Moreover, the position of the plant on the groove in the direction in which the bottom surface is inclined is also determined.

The plant cultivation device in accordance with an eighth aspect of the present invention may be configured such that, in the seventh aspect, an interval between adjacent ones of the plurality of planting holes along the direction in which the bottom surface is inclined is not less than 150 mm but not more than 250 mm. This makes it possible to make a light-receiving posture and light-receiving efficiency favorable, in a case where the plant is, for example, a strawberry.

The plant cultivation device in accordance with a ninth aspect of the present invention may be configured such that, in any one of the first through eighth aspects, an outer width of the cultivation bed is not less than 250 mm but not more than 400 mm. This makes it possible to increase the number of cultivation beds that can be installed per unit area, and consequently makes it possible to increase a planting density and thereby improve productivity of plant cultivation.

The plant cultivation device in accordance with a tenth aspect of the present invention is preferably configured such that, in any one of the first through ninth aspects, the bottom surface is inclined in a long direction. This makes it possible to uniformly supply the nutrient solution in a width direction of the cultivation bed, even in a case where a width with which the nutrient solution is discharged from the first solution supply member is narrowed.

The plant cultivation device in accordance with an eleventh aspect of the present invention may be configured to be a device for cultivating a strawberry, in any one of the first through tenth aspects. The plant cultivation device in accordance with an aspect of the present invention can be suitably used as a device for cultivating a strawberry, which takes a relatively long cultivation period and which forms a thick root mat.

The plant cultivation device in accordance with a twelfth aspect of the present invention is preferably configured to, in any one of the first through eleventh aspects, include a nutrient solution supply amount control device for controlling an amount of the nutrient solution supplied, wherein the nutrient solution supply amount control device controls the amount of the nutrient solution supplied from each of the first solution supply member and the second solution supply member such that a ratio of the amount of the nutrient solution supplied from the second solution supply member per unit time to a total of (i) the amount of the nutrient solution supplied from the first solution supply member per unit time and (ii) the amount of the nutrient solution supplied from the second solution supply member per unit time is not less than 0.2 but not more than 0.4. By controlling a first nutrient solution supply amount and a second nutrient solution supply amount within the above range, it is possible to reduce the concentration gradient and the temperature gradient of the nutrient solution between an upstream side and a downstream side in a direction in which the nutrient solution flows.

A plant cultivation method in accordance with a thirteenth aspect of the present invention is a method for cultivating a plant with use of the plant cultivation device of in any one of the first through twelfth aspects, the method including: a disposing step of disposing a plant on the bottom surface or, in a case where a groove in which the plant is placed is provided to the bottom surface, a bottom surface of the groove; and a nutrient solution supplying step of supplying a nutrient solution on the bottom surface of the cultivation bed from each of the first solution supply member and the second solution supply member, wherein in the nutrient solution supplying step, the nutrient solution is supplied from each of the first solution supply member and the second solution supply member such that a ratio of an amount of the nutrient solution supplied from the second solution supply member per unit time to a total of (i) an amount of the nutrient solution supplied from the first solution supply member per unit time and (ii) the amount of the nutrient solution supplied from the second solution supply member per unit time is not less than 0.2 but not more than 0.4. The plant cultivation method in accordance with the thirteenth aspect of the present invention makes it possible to reduce the concentration gradient and the temperature gradient of the nutrient solution between the upstream side and the downstream side of a flow of the nutrient solution.

The plant cultivation method in accordance with a fourteenth aspect of the present invention may be configured such that, in the thirteenth aspect, at least a portion of the plant is accommodated in a container having a water permeation part. In the plant cultivation method in accordance with an aspect of the present invention, the plant is transplanted on the bottom surface on which the nutrient solution of NFT flows or in the groove which is provided to the bottom surface, in a state where the plant is accommodated in the container. By using the container, it is possible to prevent a culture medium from flowing out along with the flow of the nutrient solution. Thus, it is possible to maintain the posture of the plant. As a result, it is possible to, for example, promote uniform light reception. In a case where positioning member (described later) is provided, it is possible to integrally fix the positioning member and the container, which provides convenience.

The plant cultivation method in accordance with a fifteenth aspect of the present invention is preferably configured such that, in the fourteenth aspect, a sheet member having water permeability is provided between a root ball part of the plant and an inner wall of the container. This makes it possible to prevent the culture medium from flowing out from the water permeation part due to the flow of the nutrient solution.

The plant cultivation method in accordance with a sixteenth aspect of the present invention is preferably configured such that, in the fifteenth aspect, at least one of the container and the sheet member is made of a biodegradable material. This eliminates the need for sorting during cleanup after use, and accordingly makes it possible to reduce a workload. Moreover, it is also possible to reduce an environmental load.

The plant cultivation method in accordance with a seventeenth aspect of the present invention may be configured such that, in any one of the thirteenth to sixteenth aspects, an electric conductivity of the nutrient solution is not less than 0.2 dS/m but not more than 1.0 dS/m. Since the nutrient solution having an electric conductivity falling within the above range has a low concentration of a fertilizer component, a difference in concentration of the nutrient solution is likely to significantly affect growth of the plant. The plant cultivation method in accordance with an aspect of the present invention makes it possible to reduce the concentration gradient of the nutrient solution between the upstream side and the downstream side of the flow of the nutrient solution, and is therefore also suitable for cultivation of a plant with use of a nutrient solution having a relatively low concentration of a fertilizer component.

The plant cultivation method in accordance with an eighteenth aspect of the present invention may be configured such that, in any one of the thirteenth through seventeenth aspects, the plant is a strawberry. The plant cultivation method in accordance with an aspect of the present invention is suitable as a method for cultivating a strawberry, which takes a relatively long cultivation period and which forms a thick root mat.

### Advantageous Effects of Invention

An aspect of the present invention is capable of providing a technique that makes it possible to reduce the concentration gradient and the temperature gradient of a nutrient solution between the upstream side and the downstream side of a flow of the nutrient solution.

### BRIEF DESCRIPTION OF DRAWINGS

FIG. 1 is a perspective view illustrating a configuration of a plant cultivation device in accordance first embodiment of the present invention.

FIG. 2 is a perspective view partially illustrating a configuration derived by removing a transplanting panel plate from the plant cultivation device illustrated in FIG. 1.

FIG. 3 is a cross-sectional view illustrating the configuration of the plant cultivation device in accordance with the first embodiment of the present invention, and is a cross-sectional view taken along a line A-A′ illustrated in FIG. 1.

FIG. 4 is a top view illustrating an example of a configuration of the transplanting panel plate.

### DESCRIPTION OF EMBODIMENTS

### <1. Plant Cultivation Device>

### [Outline]

A plant cultivation device in accordance with an aspect of the present invention is configured to include: a cultivation bed having a bottom surface on which a plant is placed and which is inclined; a first solution supply member for supplying a nutrient solution into the cultivation bed; and a second solution supply member extending along a direction in which the bottom surface is inclined, wherein the second solution supply member includes a plurality of discharge holes for discharging the nutrient solution, and the plurality of discharge holes are disposed along the direction in which the bottom surface is inclined.

A plant cultivation device in accordance with another aspect of the present invention may be configured to include: a cultivation bed having a bottom surface which is inclined; a first solution supply member for supplying a nutrient solution into the cultivation bed; and a second solution supply member extending along a direction in which the bottom surface is inclined, wherein a groove in which a plant is placed is provided to the bottom surface, the second solution supply member includes a plurality of discharge holes for discharging the nutrient solution, and the plurality of discharge holes are disposed along the direction in which the bottom surface is inclined.

The plant cultivation device in accordance with an aspect of the present invention is particularly suitable for use in cultivating a plant by NFT. An aspect of the present invention makes it possible to, in a plant cultivation device in which NFT is employed, reduce the concentration gradient and the temperature gradient of a nutrient solution between an upstream side and a downstream side of a flow of the nutrient solution, the concentration gradient and the temperature gradient resulting from the flow of the nutrient solution being blocked downstream by a formed root mat. As a result, it is possible to favorably grow a plant over the entire region of the flow of the nutrient solution in a cultivation bed, and possible to increase the uniformity of growth of the entire planted plant.

### (Nutrient Solution)

In the plant cultivation device in accordance with an aspect of the present invention, the nutrient solution supplied into the cultivation bed is not particularly limited, provided that the nutrient solution is water used for plant cultivation. For example, the nutrient solution is s preferably water containing any of fertilizer components such as nitrogen, phosphorus, and potassium.

In the plant cultivation device in accordance with an aspect of the present invention, the nutrient solution supplied from the first solution supply member and the nutrient solution supplied from the second solution supply member may have the same or different composition. In a case where the nutrient solution that has finished flowing through the cultivation bed is recovered and then returned to the cultivation bed for recirculation, the nutrient solution having the same composition is preferably supplied from each of the first solution supply member and the second solution supply member.

### (Plant)

In the plant cultivation device in accordance with an aspect of the present invention, the plant placed on the bottom surface of the cultivation bed or in the groove provided to the bottom surface is a seed of the plant or a seedling of the plant. In a case where the seedling is raised with use of a culture medium, it is possible to use the seedling together with the culture medium for transplanting. Thus, the plant is preferably a cell-grown seedling. In an aspect of the present invention, the plant is transplanted in a place where the nutrient solution flows. Therefore, at least a portion of the plant is preferably accommodated in a container having a water permeation part. Therefore, in the present invention, the meaning of the phrase “the plant is placed” also includes the meaning that the container in which at least a portion of the plant is accommodated is placed.

As the container, a container usually used for plant cultivation, such as a pot, can suitably be used. The shape of the container is not particularly limited. The container preferably has the water permeation part so that the nutrient solution can penetrate into the container. The water permeation part is not particularly limited, provided that the water permeation part has a structure which allows water or the nutrient solution to pass therethrough and enables rooting. For example, the water permeation part can have a structure in which openings spaced at appropriate intervals are provided or a mesh structure. The water permeation part is preferably provided to a bottom surface so as to enable water to be supplied to the plant also in a case where a water depth is shallow. From the viewpoint of ease of rooting and promotion of generation of a lateral root, the water permeation part is preferably further provided to a side surface of the container.

From the viewpoint of preventing the culture medium from flowing out through the water permeation part due to a flow of the nutrient solution, a sheet member having water permeability is preferably provided between a root ball part of the plant and an inner wall f the container. The sheet member having water permeability is not particularly limited, provided that the sheet member does not transmit the culture medium but can transmit moisture or a component contained in the nutrient solution. The sheet member having water permeability may further have, in addition to the water permeability, at least one of water holding capacity which allows the moisture to be held in the sheet and hydrophilicity which allows the moisture to spread across a surface of the sheet. The sheet member having water permeability may have both water holding capacity and hydrophilicity. In a case where the sheet member having water permeability further has water holding capacity, the sheet member having water permeability can suck up and hold the nutrient solution, so that it is possible to efficiently supply the nutrient solution to the plant. In a case where the sheet member having water permeability further has hydrophilicity, the sheet member having water permeability integrates well with the nutrient solution, so that it is possible to more uniformly spread the nutrient solution over the entire surface of the sheet member having water permeability.

As the sheet member having water permeability, suitably used can be, for example, a known agricultural root barrier sheet or root cutting sheet; a woven fabric usually used as a fabric for clothing or the like (e.g., cotton woven fabric, polyester woven fabric, hemp woven fabric, or the like); an agricultural non-woven fabric (e.g., a non-woven fabric including, for example, cotton fibers, rayon fibers, acrylic fibers, nylon fibers, polypropylene fibers, polyester fibers, or the like); or the like. The sheet member may be a sheet made of a biodegradable plastic, such as a polylactic acid (PLA) sheet, because such a sheet (i) eliminates the need for sorting during cleanup after use and accordingly makes it possible to reduce a workload and also (ii) makes it possible to reduce an environmental load. The biodegradable plastic is preferably at least one selected from the group consisting of PLA, poly(3-hydroxybutyrate-co-3-hydroxyhexanoate) (PHBH), BioPBS, polybutylene adipate terephthalate (PBAT), starch polyester resin, cellulose acetate, polyvinyl alcohol (PVA), polyglycolic acid (PGA), polybutylene succinate (PBS), polybutylene succinate adipate (PBSA) and polyethylene terephthalate succinate (PETS), and is more preferably PLA because PLA is bio-based.

From the viewpoint of reducing a load on the environment, at least one of the container and the sheet member having water permeability is preferably made of a biodegradable material. The biodegradable material is preferably, for example, at least one selected from the group consisting of PLA, PHBH, BioPBS, PBAT, starch polyester resin, cellulose acetate, PVA, PGA, PBS, PBSA, and PETS, and is more preferably PLA because PLA is bio-based. PLA is biodegradable and can be produced from a plant-derived material. Therefore, PLA can be suitably used as materials of the container and the sheet member having water permeability.

The plant that can be cultivated in the plant cultivation device in accordance with an aspect of the present invention is not particularly limited. In the plant cultivation device in accordance with an aspect of the present invention, various types of plants can be cultivated. Examples of such plants include strawberries, herbs, leafy and stem vegetables, and legumes. As described above, the plant cultivation device in accordance with an aspect of the present invention is also suitable for cultivation of a plant which forms a thick root mat. Examples of the plant which forms a thick root mat include strawberries, herbs, leafy and stem vegetable, and legumes. The plant cultivation device in accordance with an aspect of the present invention can be a device for cultivating a strawberry.

### Embodiment 1

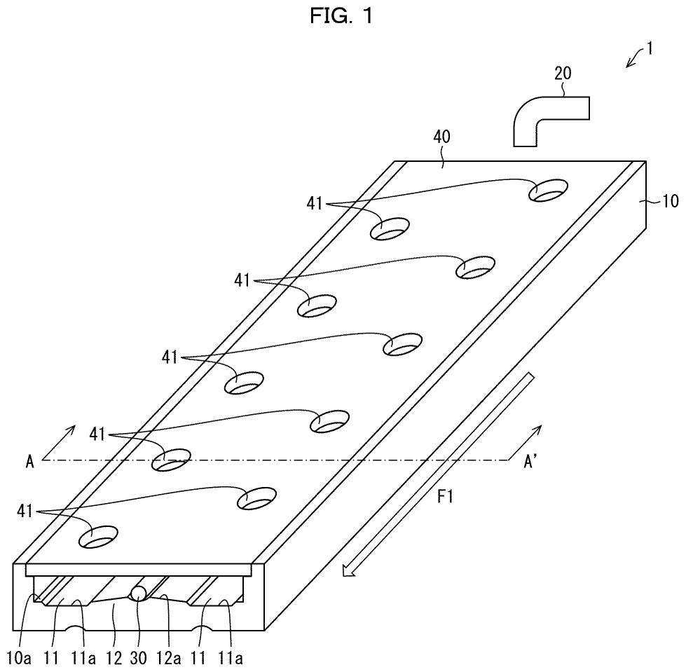

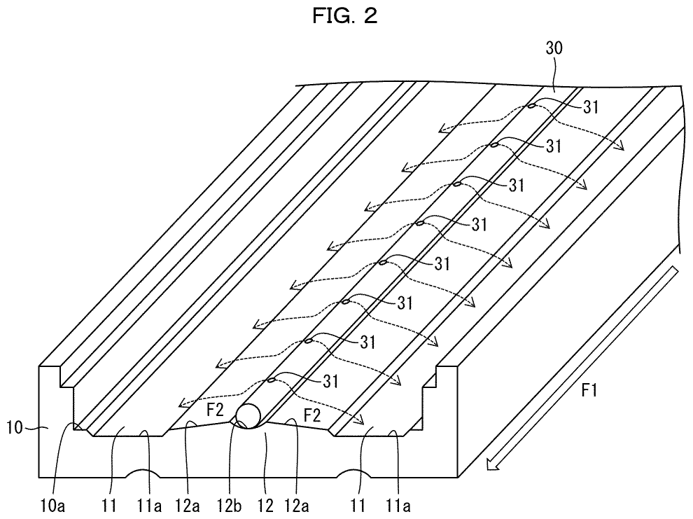

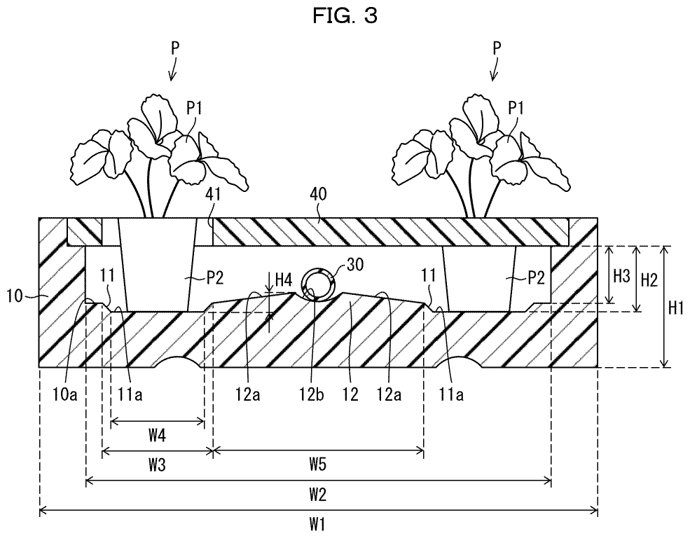

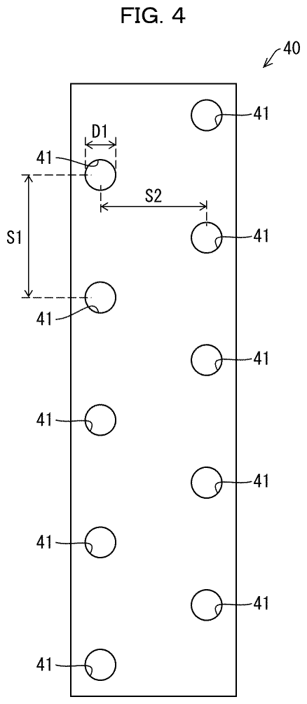

The plant cultivation device in accordance with an embodiment of the present invention will be described with reference to FIGS. 1 to 4. FIG. 1 is a perspective view illustrating a configuration of a plant cultivation device 1 in accordance with a first embodiment of the present invention. FIG. 2 is a perspective view partially illustrating a configuration derived by removing a transplanting panel plate 40 from the plant cultivation device 1 illustrated in FIG. 1. FIG. 3 is a cross-sectional view illustrating the configuration of the plant cultivation device 1 in accordance with the first embodiment of the present invention, and is a cross-sectional view taken along a line A-A′ illustrated in FIG. 1. FIG. 4 is a top view illustrating an example of a configuration of the transplanting panel plate 40. In the first embodiment, described is an aspect in which a groove in which a plant is placed is provided to a bottom surface of a cultivation bed and the plant is placed in the groove.

As illustrated in FIG. 1, the plant cultivation device 1 in accordance with the first embodiment includes a cultivation bed 10, a water discharge port (first solution supply member) 20, a drip tube (second solution supply member) 30, and the transplanting panel plate (positioning member) 40.

### (Cultivation Bed 10)

The cultivation bed 10 is a place where a plant is cultivated. A bottom surface 10a of the cultivation bed 10 is inclined in a long direction. The water discharge port 20 for supplying a nutrient solution into the cultivation bed 10 is provided at the most upstream end of the cultivation bed 10 (end portion of the cultivation bed 10 which end portion is located at the highest position from a horizontal plane).

Since the bottom surface 10a of the cultivation bed 10 is inclined in a specific direction, the nutrient solution supplied from the water discharge port 20 to the cultivation bed 10 flows on the bottom surface 10a from upstream to downstream in the cultivation bed 10 under its own weight. In the present specification, a direction in which the nutrient solution supplied from the water discharge port 20 flows on the bottom surface 10a in the cultivation bed 10 is referred to as a “flow direction of the nutrient solution”. An arrow F1 in the drawings indicates a direction in which the bottom surface 10a is inclined. The flow direction of the nutrient solution, which flows from upstream to downstream in the cultivation bed 10, is the same as this inclination direction F1 of the bottom surface 10a. Inclining the bottom surface 10a of the cultivation bed 10 in the long direction enables uniform supply of the nutrient solution in a width direction of the cultivation bed, even in a case where a width with which the nutrient solution is discharged from the first solution supply member is narrowed. Moreover, since a discharge port of the first solution supply member from which the nutrient solution is discharged is provided in a short direction of the cultivation bed, it is possible to reduce the length of piping.

The inclination of an inclined surface of the bottom surface 10a of the cultivation bed 10 is set, as appropriate, so that the nutrient solution supplied from the water discharge port 20 into the cultivation bed 10 has a flow gradient from the most upstream end toward the most downstream end in the long direction. For example, in the present embodiment, the bottom surface 10a of the cultivation bed 10 is inclined with a gradient of approximately 1/100 with respect to the horizontal plane, but the present invention is not limited thereto. For example, the bottom surface 10a can be inclined with a gradient in the range of approximately 1/80 to 1/200 with respect to the horizontal plane. Note that, in the present embodiment, the cultivation bed 10 is installed such that the entire cultivation bed 10 is inclined with respect to the horizontal plane, so that the bottom surface 10a is inclined. However, the cultivation bed 10 may be installed horizontally, by molding an upper surface of a bottom plate of the cultivation bed 10 such that the bottom surface 10a is inclined.

As illustrated in FIG. 2, two grooves 11 and one raised part 12 are provided to the bottom surface 10a of the cultivation bed 10. The grooves 11 and the raised part 12 extend along the inclination direction F1 of the bottom surface 10a. The raised part 12 is provided between the two adjacent grooves 11.

As illustrated in FIG. 3, a plant P is placed on each of bottom surfaces 11a of the grooves 11. By providing the grooves 11 to the bottom surface 10a, a difference arises in height between the bottom surface 10a of the cultivation bed 10 and the bottom surfaces 11a of the grooves 11, and accordingly the nutrient solution flows into the grooves 11. This makes it possible to efficiently direct the nutrient solution into the grooves 11. As a result, it is possible to successfully supply the nutrient solution to the plant P placed in each of the grooves 11. Moreover, since the grooves 11 extend along the inclination direction F1 of the bottom surface 10a, the nutrient solution in the grooves 11 favorably flows.

On the raised part 12, the drip tube 30 is placed. A groove 12b for positioning the drip tube 30 is provided to an upper surface of the raised part 12, and the drip tube 30 is disposed in the groove 12b. The raised part 12 further has inclined portions 12a each of which is inclined toward the bottom surface 10a. The shape of the raised part 12 is not particularly limited. However, in a case where the raised part 12 has the inclined portions 12a on the bottom surface 10a, the nutrient solution is more favorably diffused in a direction away from the drip tube 30 (e.g., the short direction of the cultivation bed 10), from the drip tube 30 placed on the raised part 12.

FIG. 3 illustrates, as an example, a configuration in which two grooves 11 are provided to the bottom surface 10a of the cultivation bed 10 and the raised part 12 is provided between the two adjacent grooves 11. However, the present invention is not limited thereto. For example, the number of grooves 11 provided to the bottom surface 10a of the cultivation bed 10 may be one or may be more than two. Moreover, the number of raised parts 12 may be determined in accordance with the number of drip tubes 30 included in the plant cultivation device 1. Furthermore, the position on the bottom surface 10a at which position the raised part 12 is provided may be determined in accordance with a position at which the drip tube 30 is disposed.

The size of the cultivation bed 10 can be determined as desired. As an example, the length, in the long direction, of one bed obtained by connecting a plurality of cultivation beds 10 is preferably not less than 10 m and more preferably not less than 15 m. The length, in the long direction, of each of the cultivation beds 10 constituting the bed is preferably not more than 1,500 mm, more preferably not more than 1,200 mm, and particularly preferably not more than 1,000 mm.

The outer width W1 of the cultivation bed 10 is preferably not less than 250 mm, and more preferably not less than 280 mm. Moreover, the outer width W1 can be set to not more than 400 mm, and is preferably not more than 350 mm, and more preferably not more than 320 mm. The cultivation bed 10 having an outer width W1 falling within the above range makes it possible to increase the number of cultivation beds that can be installed per unit area, and consequently makes it possible to increase a planting density and thereby improve the productivity of plant cultivation per unit area.

The inner width W2 of the cultivation bed 10 is preferably not less than 200 mm, and more preferably not less than 220 mm, from the viewpoint of compactness of a system. The upper limit of the inner width W2 is not particularly limited, but is preferably not more than 90% and more preferably not more than 85% of the outer width W1.

The height H1 from a lower surface of the bottom plate of the cultivation bed 10 to a lower surface of the transplanting panel plate 40 is preferably not less than 50 mm, and more preferably not less than 60 mm, from the viewpoint of compactness of the system. The height H1 is preferably not more than 75 mm, and more preferably not more than 70 mm.

The height H2 from each of the bottom surfaces 11a of the grooves 11 to the lower surface of the transplanting panel plate 40 is preferably not less than 28 mm, and more preferably not less than 32 mm, from the viewpoint of a relationship with a root ball part of a seedling. The upper limit of the height H2 is not particularly limited, but is preferably not more than 60% and more preferably not more than 55% of the height H1, from the viewpoint of strength and heat insulation.

The height H3 from the bottom surface 10a of the cultivation bed 10 to the lower surface of the transplanting panel plate 40 is preferably not less than 35 mm, and more preferably not less than 40 mm, from the viewpoint of securing aeration for the root ball part. The upper limit of the height H3 is not particularly limited, but is preferably not more than 90% and more preferably not more than 88% of the height H2, from the viewpoint of securing the flow of the nutrient solution in the initial stage of the cultivation.

The size of each of the grooves 11 is not particularly limited, and can be set, as appropriate, to a size that allows the plant P to be disposed. The width W3 of an opening of each of the grooves 11 is preferably not less than 65 mm, and more preferably not less than 70 mm, from the viewpoint of reliable supply of the nutrient solution. The upper limit of the width W3 is not particularly limited, but is preferably not more than 35% and more preferably not more than 30% of the inner width W2 of the cultivation bed 10, from the viewpoint of securing a damp space.

The width W4 of each of the bottom surfaces 11a of the grooves 11 is preferably not less than 40 mm, and more preferably not less than 45 mm, from the viewpoint of reliably securing the flow of the nutrient solution. The upper limit of the width W4 is not particularly limited, but is preferably not more than 90% and more preferably not more than 85% of the width W3, from the viewpoint of securing the water depth immediately after transplanting.

The size of the raised part 12 is not particularly limited, and can be set as appropriate. The width W5 of the raised part 12 is preferably not less than 100 mm, and more preferably not less than 108 mm, from the viewpoint of diffusibility of the nutrient solution from the drip tube 30. The upper limit of the width W5 is not particularly limited, but is preferably not more than 55% and more preferably not more than 50% of the inner width W2 of the cultivation bed 10, from the viewpoint of reliably securing the flow of the nutrient solution in the initial stage of the cultivation. Note, here, that the phrase “width of the raised part 12” means a width at a bottom surface of the raised part 12.

The height H4 from each of the bottom surfaces 11a of the grooves 11 to the highest position of the raised part 12 is preferably not less than 5 mm, and more preferably not less than 8 mm, from the viewpoint of the diffusibility of the nutrient solution from the drip tube 30. The upper limit of the height H4 is not particularly limited, but is preferably not more than 40% and more preferably not more than 35% of the height H3 from the bottom surface 10a of the cultivation bed 10 to the lower surface of the transplanting panel plate 40, from the viewpoint of securing an effective flow of the nutrient solution in the middle and late stages of the cultivation.

The cultivation bed 10 is preferably made of a heat insulating material. This makes it unlikely that the inside of the cultivation bed 10 is affected by an external temperature. Examples of the heat insulating material include known heat insulating materials such as polystyrene foam. Among these, polystyrene foam can be suitably used as a material from which the cultivation bed 10 is formed, because polystyrene foam is inexpensive and lightweight. For the purpose of preventing the nutrient solution from leaking out from the cultivation bed 10, it is preferable to cover, with a waterproof sheet or an impermeable sheet (not illustrated), at least a portion of an inner surface of the cultivation bed 10 which portion comes into contact with the nutrient solution. The waterproof sheet or the impermeable sheet is not particularly limited, provided that the waterproof sheet or the impermeable sheet is made of a material that is unlikely to transmit moisture or that does not transmit moisture at all. A known waterproof sheet or impermeable sheet can be suitably used.

### (Water Discharge Port 20)

The nutrient solution is supplied from the water discharge port 20 into the cultivation bed 10. The water discharge port 20 is not particularly limited in configuration, provided that the nutrient solution can be supplied so as to flow on the bottom surface 10a of the cultivation bed 10.

In the present embodiment, a configuration in which the water discharge port 20 is provided at the most upstream end of the cultivation bed 10 has been described by way of example. However, the present invention is not limited thereto. The position at which the water discharge port 20 is provided is not particularly limited, provided that the nutrient solution can be supplied as uniformly as possible onto the bottom surface 10a of the cultivation bed 10.

### (Drip Tube 30)

The nutrient solution is supplied from the drip tube 30 onto the bottom surface 10a of the cultivation bed 10. As illustrated in FIG. 2, the drip tube 30 extends along the inclination direction F1 of the bottom surface 10a. The drip tube 30 includes a plurality of discharge holes 31 for discharging the nutrient solution. The plurality of discharge holes 31 are disposed along the inclination direction F1 of the bottom surface 10a. The drip tube 30 is placed on the raised part 12.

As illustrated in FIG. 2, the nutrient solution discharged from each of the discharge holes 31 of the drip tube 30 flows along the inclined portions 12a of the raised part 12 (flows F2 indicated by broken line arrows in FIG. 2), and flows into the grooves 11. In this manner, by providing the drip tube 30, it is possible to supply the nutrient solution along the flow direction of the nutrient solution. Therefore, it is also possible to supply the nutrient solution to the downstream side of the cultivation bed 10. As a result, it is possible to reduce the concentration gradient and the temperature gradient of the nutrient solution in the flow direction of the nutrient solution.

The drip tube 30 only needs to extend along the inclination direction F1 of the bottom surface 10a, and a position on the bottom surface 10a at which position the drip tube 30 is disposed is not particularly limited. However, in a case where a plurality of grooves 11 are provided to the bottom surface 10a of the cultivation bed 10, the drip tube 30 is preferably disposed between adjacent ones of the plurality of grooves 11. This makes it possible to supply the nutrient solution from the drip tube 30 evenly to two adjacent grooves 11, and therefore makes it possible to reduce a difference in concentration and temperature of the nutrient solution between the two adjacent grooves 11.

Moreover, by placing the drip tube 30 on the raised part 12, it is possible to further cause a difference in height between (i) the discharge holes 31 of the drip tube 30 and (ii) the bottom surfaces 11a of the grooves 11. Therefore, the nutrient solution supplied from the discharge holes 31 easily flows into the grooves 11 under its own weight.

Furthermore, it is possible to supply the nutrient solution along side surfaces (inclined portions 12a) of the raised part 12. Therefore, the nutrient solution is favorably diffused in the direction away from the drip tube 30 (for example, the short direction of the cultivation bed 10). As a result, it is possible to further reduce the concentration gradient and the temperature gradient of the nutrient solution in the short direction of the cultivation bed 10.

As the drip tube, a drip tube usually used for drip irrigation can be used. Examples of the drip tube include STREAMLINE manufactured by Netafim.

In the present embodiment, the drip tube 30 is used as an example of the second solution supply member. However, the second solution supply member is not limited to the drip tube, provided that the nutrient solution can be supplied along the inclination direction F1 of the bottom surface 10a. As the second solution supply member, a tubular member that has a plurality of discharge holes disposed along a long direction of the tube can be suitably used. For example, a sprinkling tube usually used, such as EVAFLOW™ manufactured by Mitsubishi Chemical Agri Dream Co., Ltd., can be used.

In the present embodiment, a configuration in which one drip tube 30 is disposed with respect to two grooves 11 has been described by way of example. However, the present invention is not limited thereto. The number of drip tubes 30 can be determined, as appropriate, with respect to the number of grooves 11.

Furthermore, in the present embodiment, a configuration in which, in a case where the cultivation bed 10 includes a plurality of grooves 11, the drip tube 30 is disposed between adjacent ones of the plurality of grooves 11 has been described by way of example. However, the present invention is not limited thereto. A position at which the drip tube 30 is disposed can be determined as appropriate. The drip tube 30 may be disposed such that there is a groove 11 that is not adjacent to the drip tube 30.

In the present embodiment, a configuration in which one raised part 12 is provided with respect to one drip tube 30 and the drip tube 30 is placed on the raised part 12 has been described by way of example. However, the present invention is not limited thereto. It is only necessary that the drip tube 30 can supply the solution from a position higher than those of the bottom surfaces 11a of the grooves 11. Therefore, the drip tube 30 may be placed directly on the bottom surface 10a without providing the raised part 12 to the bottom surface 10a of the cultivation bed 10. Alternatively, the drip tube 30 may be suspended from the transplanting panel plate 40 without being disposed on the bottom surface 10a of the cultivation bed 10.

### (Transplanting Panel Plate 40)

The transplanting panel plate 40 is placed on an open top of the cultivation bed 10. The transplanting panel plate 40 is preferably made of the same heat insulating material as that of the cultivation bed 10. This makes it unlikely that the inside of the cultivation bed 10 is affected by an external temperature, and makes it possible to maintain the temperature of the nutrient solution in the cultivation bed 10 at a constant temperature. Moreover, by shallowing the water depth of the nutrient solution flowing in the cultivation bed and providing a space between a water surface and the lower surface of the transplanting panel plate, it is possible to make this space a damp space, and it is possible to supply oxygen to a root of the plant which grows in the damp space.

As illustrated in FIG. 4, a plurality of planting holes 41 are provided in the transplanting panel plate 40 at regular intervals along the inclination direction F1 of the bottom surface 10a. As illustrated in FIG. 3, the planting holes 41 of the transplanting panel plate 40 are provided at positions which correspond to the grooves 11 in a case where the transplanting panel plate 40 is disposed on the cultivation bed 10. This makes it possible to place the plant P in each of the grooves 11 located below the planting holes 41, by inserting the plant P into each of the planting holes 41 and thereby transplanting the plant P.

An interval between adjacent ones of the planting holes 41 along the inclination direction F1 of the bottom surface 10a (long direction of the transplanting panel plate 40 illustrated in FIG. 4) is not particularly limited, and can be designed, as appropriate, in accordance with, for example, the type of the plant to be cultivated. In a case where the plant is, for example, a strawberry, an interval S1 between adjacent ones of the planting holes 41 along the inclination direction F1 of the bottom surface 10a is preferably not less than 150 mm, and more preferably not less than 180 mm, from the viewpoint of a favorable light-receiving posture. From the viewpoint of light-receiving efficiency, the interval S1 is preferably not more than 250 mm, and more preferably not more than 220 mm. Note, here, that the interval S1 means a distance between the centers of adjacent ones of the planting holes 41.

The shape of each of the planting holes 41 may be a prism shape or any other shape, instead of a cylindrical shape illustrated in FIG. 4. As illustrated in FIG. 3, in the plant cultivation device 1 in accordance with an aspect of the present invention, the plant P is placed in each of the grooves 11 in a state where a cell-grown seedling P1 is accommodated in a pot (container) P2. Therefore, it is preferable that the shape of each of the planting holes 41 be similar to the outer peripheral shape of the pot P2. This makes it possible to reduce a gap between the pot P2 and each of the planting holes 41, and thereby improves the airtightness of the damp space. It is preferable that the size of each of the planting holes 41 be slightly (for example, about 1 mm to 2 mm) larger than the outer peripheral shape of the pot P2. This makes it possible to easily insert the plant P into each of the planting holes 41 and thereby transplant the plant P. For example, in a case where the shape of each of the planting holes 41 is a cylindrical shape as illustrated in FIG. 4, the diameter D1 of each of the planting holes 41 is preferably not less than 40 mm but not more than 55 mm.

In the present embodiment, a configuration in which the planting holes 41 are provided in two rows has been described by way of example, but the present invention is not limited thereto. The number of rows of the planting holes 41 may be determined in accordance with the number of the grooves 11. In a case where the planting holes 41 are provided in a plurality of rows, an interval S2 between adjacent ones of the rows of the planting holes 41 is preferably not less than 160 mm, and more preferably not less than 165 mm, from the viewpoint of efficient light reception and panel strength. From the viewpoint of securing the number of planted seedlings, the interval S2 is preferably not more than 185 mm, and more preferably not more than 180 mm. Note, here, that the interval S2 means a distance between the centers of adjacent ones of the planting holes 41.

The size of the transplanting panel plate 40 is not particularly limited, and can be determined, as appropriate, in accordance with the size of the open top of the cultivation bed 10.

### (Other Configurations)

A nutrient solution supply amount control device (not illustrated) and a nutrient solution storage tank (not illustrated) are connected to each of the water discharge port 20 and the drip tube 30. The nutrient solution storage tank is for storing the nutrient solution to be supplied to the cultivation bed 10. A configuration of the nutrient solution storage tank is not particularly limited, provided that the nutrient solution can be stored therein. The nutrient solution storage tank may be equipped with a sensor which measures an electric conductivity (EC) value of the nutrient solution (not illustrated), a sensor which measures a pH value (not illustrated), a sensor which measures the temperature of the nutrient solution (not illustrated), and the like. This makes it possible to control the EC value, the pH value, and the temperature of the nutrient solution within respective given ranges.

The nutrient solution supply amount control device is a device for controlling the amount of the nutrient solution supplied. The nutrient solution supply amount control device controls a solution sending pump (not illustrated) and valves (not illustrated). The solution sending pump supplies the nutrient solution in the nutrient solution storage tank to the water discharge port 20 and the drip tube 30. The valves are respectively provided to the water discharge port 20 and the drip tube 30. By controlling the degree of opening of each of the valves, it possible to adjust the amount of the nutrient solution supplied from each of the water discharge port 20 and the drip tube 30 to a given amount.

The nutrient solution supply amount control device preferably controls the amount of the nutrient solution supplied from the water discharge port 20 per unit time (first nutrient solution supply amount) and the amount of the nutrient solution supplied from the drip tube 30 per unit time (second nutrient solution supply amount) such that the ratio of the second nutrient solution supply amount to the total of the first nutrient solution supply amount and the second nutrient solution supply amount is not less than 0.2 but not more than 0.4. By controlling the first nutrient solution supply amount and the second nutrient solution supply amount within the above range, it is possible to reduce the concentration gradient and the temperature gradient of the nutrient solution between the upstream side and the downstream side in the flow direction of the nutrient solution. The nutrient solution supply amount control device may be a terminal into which the first nutrient solution supply amount and the second nutrient solution supply amount can be input, and may control opening and closing of the valves that are respectively provided to the water discharge port 20 and the drip tube 30.

A recovery member (not illustrated) for recovering the nutrient solution that has finished flowing through the cultivation bed 10 is provided to the most downstream end of the cultivation bed 10 (end portion of the cultivation bed 10 which end portion is located at the lowest position from the horizontal plane). The recovered nutrient solution may be returned to the nutrient solution storage tank and then supplied to the cultivation bed 10 again.

### (Modification)

In the above description, a configuration in which the plant device cultivation 1 includes the transplanting panel plate 40 as a positioning member has been described by way of example. However, the present invention is not limited thereto. The plant cultivation device in accordance with an aspect of the present invention may be configured not to include the transplanting panel plate 40. Even with a configuration in which the plant cultivation device 1 does not include the transplanting panel plate 40, an effect brought about by using two solution supply members, i.e., the water discharge port 20 and the drip tube 30, in combination to supply the solution can be sufficiently exhibited.

### Embodiment 2

A plant cultivation device 2 in accordance with a second embodiment of the present invention will be described below with reference to FIG. 3. The plant cultivation device 2 in accordance with the second embodiment is described with the reference sign “1” in FIG. 3 replaced with “2”.

In the first embodiment, has been described an aspect in which the grooves 11 in each of which a plant is placed are provided to the bottom surface 10a of the cultivation bed 10 of the plant cultivation device 1 and the plant P is placed in each of the grooves 11. However, the present invention is not limited thereto. The plant cultivation device 2 in accordance with the second embodiment of the present invention can be configured such that a groove 11 in which a plant is placed is not provided to a bottom surface 10a of a cultivation bed 10 and thus a recessed part is not provided to the bottom surface 10a of the cultivation bed 10. In this case, the plant P may be placed on the bottom surface 10a.

A drip tube 30 is placed on a raised part 12. Therefore, it is possible to supply a nutrient solution from a position higher than the bottom surface 10a that is a position at which the plant P is placed. This makes it possible to diffuse the nutrient solution on the bottom surface 10a in a direction away from the drip tube 30 (for example, a short direction of the cultivation bed 10), and makes it possible to sufficiently exhibit an effect brought about by using two solution supply members, i.e., a water discharge port 20 and the drip tube 30 in combination to supply the solution. Of configurations included in the plant cultivation device 2 in accordance with the second embodiment, configurations other than a configuration in which a groove 11 is not provided are the same as the respective configurations included in the plant cultivation device 1 in accordance with the first embodiment, and therefore description thereof is omitted here.

### <2. Method for Cultivating Plant>

A plant cultivation method in accordance with an aspect of the present invention is a method for cultivating a plant with use of the plant cultivation device in accordance with an aspect of the present invention, the method including: a disposing step of disposing a plant on the bottom surface or, in a case where a groove in which the plant is placed is provided to the bottom surface, a bottom surface of the groove; and a nutrient solution supplying step of supplying a nutrient solution on the bottom surface of the cultivation bed from each of the first solution supply member and the second solution supply member. The plant cultivation device in accordance with an aspect of the present invention is as already described, and description thereof is not repeated here.

(Method for Cultivating Plant in Accordance with First Embodiment)

As an aspect of the plant cultivation method of the present invention, a method for cultivating a plant with use of the plant cultivation device 1 in accordance with the first embodiment is described below with reference to FIG. 3. The method for cultivating a plant with use of the plant cultivation device 1 in accordance with the first embodiment is also referred to as a “plant cultivation method in accordance with the first embodiment”.

### (Disposing Step)

In the plant cultivation device 1 in accordance with the first embodiment, the grooves 11 in each of which the plant P is placed is provided to the bottom surface 10a of the cultivation bed 10. Therefore, in the plant cultivation method in accordance with the first embodiment, a disposing step is a step of disposing the plant P on each of the bottom surfaces 11a of the grooves 11 of the cultivation bed 10 of the plant cultivation device 1. The plant P is such that the cell-grown seedling P1 is accommodated in the pot (container) P2 having the water permeation part (not illustrated). In the disposing step, a pot P2 portion of the plant P is inserted into each of the planting holes 41 of the transplanting panel plate 40 for transplanting. This makes it possible to place the plant P on each of the bottom surfaces 11a of the grooves 11 which bottom surfaces 11a are located directly below the planting holes 41.

### (Nutrient Solution Supplying Step)

A nutrient solution supplying step is a step of supplying the nutrient solution on the bottom surface 10a of the cultivation bed 10 from each of the water discharge port 20 and the drip tube 30.

### (Solution Supply Method)

The nutrient solution may be supplied from the water discharge port 20 such that the nutrient solution flows in a thin film form on the bottom surface 10a of the cultivation bed 10 (i.e., NFT). The nutrient solution is supplied from the drip tube 30 by a drip irrigation method (for example, a dripping solution supply method). However, the present invention is not limited thereto. Since the nutrient solution only needs to be supplied from the second solution supply member such that the nutrient solution is supplied along the inclination direction F1 of the bottom surface 10a, it is also possible to employ, instead of the drip tube, a sprinkling tube as the second solution supply member. In a case where the sprinkling tube is used as the second solution supply member, the nutrient solution is supplied by a sprinkling method.

The sprinkling method makes it possible to release the nutrient solution in a wider range than the drip irrigation method. In contrast, in a case where the cultivation bed having a small space therein is used, the drip irrigation method has an advantage that the inside and the outside of the cultivation bed is unlikely to be soiled by the nutrient solution and accordingly the cultivation bed can be continuously used for a long time period, an advantage that it is possible to accurately control the amount of the nutrient solution discharged, and the like. Therefore, in a case where cultivation is carried out for a long time period with use of the cultivation bed having a small space therein, it is preferable to supply the nutrient solution by the drip irrigation method with use of the drip tube as the second solution supply member.

### (Amount of Nutrient Solution Supplied)

In the nutrient solution supplying step, it is preferable to supply the nutrient solution from each of the water discharge port 20 and the drip tube 30 such that the ratio of the amount of the nutrient solution supplied from the drip tube 30 per unit time (second nutrient solution supply amount) to the total of (i) the amount of the nutrient solution supplied from the water discharge port 20 per unit time (first nutrient solution supply amount) and (ii) the second nutrient solution supply amount is not less than 0.2 but not more than 0.4. By setting the amount of the nutrient solution supplied from each of the water discharge port 20 and the drip tube 30 such that the above ratio is achieved, it is possible to reduce the concentration gradient and the temperature gradient of the nutrient solution between the upstream side and the downstream side of the flow of the nutrient solution.

### (Level of Nutrient Solution)

The total of the first nutrient solution supply amount and the second nutrient solution supply amount may be adjusted, as appropriate, such that the level of the nutrient solution flowing through the cultivation bed 10 in the nutrient solution supplying step becomes a level suitable for growth of a cultivation target plant. For example, in a case where the cultivation target plant is a strawberry, the height from each of the bottom surface 11a of the grooves 11 to the surface of the nutrient solution is preferably not less than 1.5 mm and more preferably not less than 2 mm in a very early stage of cultivation, from the viewpoint of reliable supply of the nutrient solution. From the viewpoint of securing the damp space at the root ball part of the seedling, the height from each of the bottom surfaces 11a of the grooves 11 to the surface of the nutrient solution is preferably not more than 25 mm and more preferably not more than 20 mm. Note that the level of the nutrient solution in the nutrient solution supplying step is a set value, and, in actual control, the level of the nutrient solution may therefore partially or temporarily deviate from the above range.

### (Temperature of Nutrient Solution)

The temperature of the nutrient solution may be adjusted, as appropriate, so as to be a temperature suitable for growth of the cultivation target plant. For example, in a case where the cultivation target plant is a strawberry, the temperature of the nutrient solution supplied to the cultivation bed 10 in the nutrient solution supplying step is preferably not lower than 13° C. and more preferably not lower than 15° C., from the viewpoint of the physiology of the root, i.e., general activity related to growth of the root. From the viewpoint of preventing a high temperature damage from occurring in the strawberry, the temperature of the nutrient solution supplied to the cultivation bed 10 in the nutrient solution supplying step is preferably not higher than 25° C. and more preferably not higher than 20° C.

### (Electric Conductivity of Nutrient Solution)

The electric conductivity of the nutrient solution may be adjusted, as appropriate, so as to be an electric conductivity suitable for growth of the cultivation target plant. For example, in a case where the cultivation target plant is a strawberry, the electric conductivity of the nutrient solution supplied to the cultivation bed 10 in the nutrient solution supplying step is preferably not less than 0.2 dS/m but not more than 1.0 dS/m, more preferably not less than 0.2 dS/m but not more than 0.8 dS/m, and even more preferably not less than 0.2 dS/m but not more than 0.6 dS/m. In the present specification, the “electric conductivity” is obtained with use of an electric conductivity measurement meter, and is a value obtained by immersing an electric conductivity cell in a test solution, measuring a resistance, and then calculating a reciprocal f the resistance. Since the nutrient solution having an electric conductivity falling within the above range has a low concentration of a fertilizer component, a difference in concentration of the nutrient solution is likely to significantly affect growth of the plant. The plant cultivation method in accordance with an aspect of the present invention makes it possible to reduce the concentration gradient of the nutrient solution between the upstream side and the downstream side of the flow of the nutrient solution, and is therefore also suitable for cultivation of a plant with use of a nutrient solution having a relatively low concentration of a fertilizer component.

(Method for Cultivating Plant in Accordance with Second Embodiment)

As another aspect of the plant cultivation method of the present invention, a method for cultivating a plant with use of the plant cultivation device in accordance with the second embodiment is described below with reference to FIG. 3. The method for cultivating a plant with use of the plant cultivation device in accordance with the second embodiment is also referred to as a “plant cultivation method in accordance with the second embodiment”.

### (Disposing Step)

In the plant cultivation method in accordance with the second embodiment, a disposing step is a step of disposing the plant P on the bottom surface 10a of the cultivation bed 10 of the plant cultivation device 2. The disposing step is similar to the disposing step in the plant cultivation method in accordance with the first embodiment, except that a place where the plant P is disposed is different.

### (Nutrient Solution Supplying Step)

A nutrient solution supplying step is a step of supplying the nutrient solution on the bottom surface 10a of the cultivation bed 10 from each of the water discharge port 20 and the drip tube 30. Also in the plant cultivation method in accordance with the second embodiment, the total of the first nutrient solution supply amount and the second nutrient solution supply amount may be adjusted, as appropriate, such that the level of the nutrient solution flowing through the cultivation bed 10 in the nutrient solution supplying step becomes a level suitable for growth of a cultivation target plant, as in the plant cultivation method in accordance with the first embodiment. Note, however, that, in the plant cultivation method in accordance with the first embodiment, the preferable level of the nutrient solution may be determined on the basis of the height from each of the bottom surfaces 11a of the grooves 11 to the surface of the nutrient solution, whereas, in the plant cultivation method in accordance with the second embodiment, the preferable level of the nutrient solution may be determined on the basis of the height from the bottom surface 10a to the surface of the nutrient solution. Except this point, the nutrient solution supplying step is similar to the nutrient solution supplying step in the plant cultivation method in accordance with the first embodiment.

The present invention is not limited to the above-described embodiments, and can be altered by a skilled person in the art within the scope of the claims. The present invention also encompasses, in its technical scope, any embodiment derived by combining technical means disclosed in differing embodiments.

### INDUSTRIAL APPLICABILITY

The present invention can be suitably used, for example, to cultivate a plant such as a strawberry, which forms a root mat.

### REFERENCE SIGNS LIST

1 Plant cultivation device, 10 Cultivation bed, 10a Bottom surface of the cultivation bed, 11 Groove, 11a Bottom surface of the groove, 12 Raised part, 12a Inclined portion of the raised part, 20 Water discharge port (first solution supply member), 30 Drip tube (second solution supply member), 31 Discharge hole, 40 Transplanting panel plate (positioning member), 41 Planting hole, F1 Inclination direction of the bottom surface 10a, P Plant, P1 Cell-grown seedling (plant), P2 Pot (container)

1. A plant cultivation device comprising:
a cultivation bed having a bottom surface on which a plant is placed and which is inclined;
a first solution supply member for supplying a nutrient solution into the cultivation bed; and
a second solution supply member extending along a direction in which the bottom surface is inclined, wherein
the second solution supply member includes a plurality of discharge holes for discharging the nutrient solution,
the plurality of discharge holes are disposed along the direction in which the bottom surface is inclined,
a raised part on which the second solution supply member is placed is provided to the bottom surface, and
the second solution supply member is placed on the raised part.

2. The plant cultivation device as set forth in claim 1, wherein the raised part has an inclined portion which is inclined toward the bottom surface.

3. The plant cultivation device as set forth in claim 1, wherein a groove in which the plant is placed is provided to the bottom surface.

4. The plant cultivation device as set forth in claim 3, wherein the groove extends along the direction in which the bottom surface is inclined.

5. The plant cultivation device as set forth in claim 3, wherein
the groove includes a plurality of grooves, and
the second solution supply member is disposed between adjacent ones of the plurality of grooves.

6. The plant cultivation device as set forth in claim 3, further comprising
a positioning member for the plant, wherein
the positioning member has a plurality of planting holes at positions which correspond to the groove in a case where the positioning member is disposed on the cultivation bed.

7. The plant cultivation device as set forth in claim 6, wherein an interval between adjacent ones of the plurality of planting holes along the direction in which the bottom surface is inclined is not less than 150 mm but not more than 250 mm.

8. The plant cultivation device as set forth in claim 1, wherein an outer width of the cultivation bed is not less than 250 mm but not more than 400 mm.

9. The plant cultivation device as set forth in claim 1, wherein the bottom surface is inclined in a long direction.

10. The plant cultivation device as set forth in claim 1, wherein the plant cultivation device is a device for cultivating a strawberry.

11. The plant cultivation device as set forth in claim 1, comprising
a nutrient solution supply amount control device for controlling an amount of the nutrient solution supplied, wherein
the nutrient solution supply amount control device controls the amount of the nutrient solution supplied from each of the first solution supply member and the second solution supply member such that a ratio of the amount of the nutrient solution supplied from the second solution supply member per unit time to a total of (i) the amount of the nutrient solution supplied from the first solution supply member per unit time and (ii) the amount of the nutrient solution supplied from the second solution supply member per unit time is not less than 0.2 but not more than 0.4.

12. A method for cultivating a plant with use of the plant cultivation device recited in claim 1, the method comprising:
a disposing step of disposing a plant on the bottom surface or, in a case where a groove in which the plant is placed is provided to the bottom surface, a bottom surface of the groove; and
a nutrient solution supplying step of supplying a nutrient solution on the bottom surface of the cultivation bed from each of the first solution supply member and the second solution supply member, wherein
in the nutrient solution supplying step, the nutrient solution is supplied from each of the first solution supply member and the second solution supply member such that a ratio of an amount of the nutrient solution supplied from the second solution supply member per unit time to a total of (i) an amount of the nutrient solution supplied from the first solution supply member per unit time and (ii) the amount of the nutrient solution supplied from the second solution supply member per unit time is not less than 0.2 but not more than 0.4.

13. The method as set forth in claim 12, wherein at least a portion of the plant is accommodated in a container having a water permeation part.

14. The method as set forth in claim 13, wherein a sheet member having water permeability is provided between a root ball part of the plant and an inner wall of the container.

15. The method as set forth in claim 14, wherein at least one of the container and the sheet member is made of a biodegradable material.

16. The method as set forth in claim 12, wherein an electric conductivity of the nutrient solution is not less than 0.2 dS/m but not more than 1.0 dS/m.

17. The method as set forth in claim 12, wherein the plant is a strawberry.
